(19) United States
(12) Patent Application Publication
(10) Pub. No.: US 2020/0067380 A1
(43) Pub. Date: Feb. 27, 2020

(54) ELECTRIC MACHINE HAVING AN AXIAL ELECTRODYNAMIC BEARING

(71) Applicant: Université Catholique de Louvain, Louvain-la-Neuve (BE)

(72) Inventors: Bruno DEHEZ, Liernu (BE); Corentin DUMONT DE CHASSART, Gentinnes (BE); Joachim VAN VERDEGHEM, Waterloo (BE); Virginie KLUYSKENS, Limal (BE)

(21) Appl. No.: 16/609,337

(22) PCT Filed: May 18, 2018
(86) PCT No.: PCT/EP2018/063174

§ 371 Date: Oct. 29, 2019

(30) Foreign Application Priority Data
May 19, 2017 (EP) 17172089.9

(51) Int. Cl. H02K 7/09; F16C 32/04

(52) U.S. Cl. CPC H02K 7/09; F16C 2380/26; F16C 32/0495

(57) ABSTRACT

The invention relates electric machine extending along an axis Z, and comprising (i) a rotor portion configured for rotating around the Z axis at a defined position along the Z axis, and comprising a field source having p pole pairs; (ii) a stator portion comprising at least one pair of windings comprising each an upper (30) and a lower (40) winding, comprising each a plurality of p pole pairs, the upper (30) and lower (40) winding being arranged so as to form a passive axial electrodynamic bearing. According to the invention, the connections (31-42, 32-41 or 31-41,32-42) between the upper (30) and lower (40) windings comprise terminals of the electric machine connectable to an electric power supply or to an electric load.

### FIELD OF THE INVENTION

The invention relates to an electric machine having an axial electrodynamic bearing having (i) a rotor portion configured for rotating around the Z axis at a defined position along the Z axis, and comprising a field source having p pole pairs; (ii) a stator portion comprising a pair of windings comprising an upper and a lower winding, comprising p pole pairs, the upper and lower winding being arranged so as to form a passive axial electrodynamic bearing.

### DESCRIPTION OF PRIOR ART

Electrodynamic bearings are based on forces issued from the interaction between a magnetic field and currents flowing in conductors. The rotor of an electric machine having an electrodynamic bearing is levitated in a contactless manner. Electrodynamic bearings comprise active electrodynamic bearings and passive electrodynamic bearings. In an active electromagnetic bearing the rotor position is monitored by sensors. A control unit commands currents in windings of the electrodynamic bearing in order to maintain in or bring back the rotor to its centered (i.e. nominal) position. These active electrodynamic bearings require sensors, power supplies for providing the currents and complex command electronics or software for controlling the currents according to the rotor position. Passive electrodynamic bearings are based on forces issued from the interaction between a magnetic field and currents induced in conductors resulting from a variation of the magnetic field seen by these conductors. This variation results from a time variation of the magnetic field or by a space variation of the field and a relative motion of the conductor. Preferably, the currents will only be induced when the rotor is not in its equilibrium position: the fact that no current flows in the conductors when the rotor is in equilibrium implies that there are no losses in this situation. These bearings are known as null-flux windings.

Document US20060279149 discloses a passive axial magnetic bearing comprising magnets and bearing coils. FIG. 16 of this document discloses an embodiment where additional drive coils are provided. The magnets 1, 2 are used for both the bearing coils and the drive coils. Bearing coils L_{A}, L_{B} are series connected in a closed circuit 3, in such a way that no current is generated in circuit 3 when the rotor is centred. When the rotor is not centred, a net flux generates a current trough circuit 3. This current exerts an axial centring force on the rotor. Drive coils L_{X}, L_{Y} are series connected in a distinct closed circuit 11, wherein a generator 13 may supply currents to circuit 11 and drive the rotor. Two distinct windings are needed in this design.

Document EP 2 677 176 discloses a compact electric centrifugal compressor. In the embodiment represented at FIG. 4, reference numeral 130 may designate an axial bearingless motor as well as an axial active magnetic bearing. A single combined winding may carry jointly the required motor and bearing currents. However, as in the other embodiments disclosed in this document, all magnetic bearings are active magnetic bearings.

Document EP 3 118 976 discloses an electric machine having a radial electromagnetic bearing. In some embodiments of this documents, a single multifunction winding performs both the function of the bearing armature winding and the motor/generator armature winding.

In a first of said embodiments, according to claim 8 of this document and described at paragraph [0033] in reference to FIG. 9a, a multifunction winding where the bearing winding has q=2 pole pairs is disclosed, in combination with an inductor having p=1 pole pair.
In a second of said embodiments, according to claim 9 of this document and described at paragraph [0033] in reference to FIG. 9b, a multifunction winding where the bearing winding has q=1 pole pairs is disclosed, in combination with an inductor having p=2 pole pairs.
In a third and last of said embodiments, according to claim 10 of this document and described at paragraph [0034] in reference to FIG. 9c, a multifunction winding where the bearing winding has q=1 pole pairs is disclosed, in combination with an inductor having p=2 pole pairs.
In all these embodiments, the closed circuit formed by connecting an electric supply or electric load between the start connector Rs and finish connector Rf forms a winding having same number of pole pairs p as the inductor, thereby producing a motor or generator effect. No other combinations besides the three discussed above have been disclosed or suggested in this document.

### SUMMARY OF THE INVENTION

It is an object of the present invention to provide an electric machine having a passive axial magnetic bearing where a single combined winding performs both the bearing function and the motor/generator function.

The invention is defined by the independent claims. The dependent claims define advantageous embodiments.

According the invention, there is provided an electric machine extending along an axis Z, and comprising:

1) a rotor portion configured for rotating around the Z axis at a defined position along the Z axis and comprising a field source having an upper field source arrangement and a lower field source arrangement producing a magnetic field, and comprising a plurality of p pole pairs uniformly distributed around the Z axis;
2) a stator portion comprising at least one pair of windings comprising each an upper and a lower winding, comprising each a plurality of p pole pairs uniformly distributed around the Z axis, said or each of said upper/lower windings having a positive reference terminal and a negative reference terminals, a current flowing into a positive reference terminal producing a flux in the positive direction in said winding, wherein for the or each pair of windings:
(i) each winding and the field source are arranged in such a way that either alternative:
(a) a flux from the field source in said upper winding is equal to the flux from the field source in said lower winding or
(b) a flux from the field source in said upper winding is opposite to the flux from the field source in said lower winding;
is realized at any time when the rotor portion rotates around the Z axis at said defined position along the Z axis;
(ii) each winding and the field source are arranged in such a way that the amplitude of a flux from the field source increases in a winding of said pair of windings and decreases in the other winding of said pair of windings when position of the rotor portion along the Z axis is different from said defined position;
(iii) the positive reference terminal of the upper winding is connected to the positive reference terminal of the lower winding and the negative reference terminal of the upper winding is connected to the negative reference terminal of the lower winding when alternative (a) is realized and the positive reference terminal of the upper winding is connected to the negative reference terminal of the lower winding and the negative reference terminal of the upper winding is connected to the positive reference terminal of the lower winding when alternative (b) is realized, forming a closed circuit path. According to the invention, the connections between the upper and lower windings comprise terminals of the electric machine directly connectable to an electric power supply or to an electric load.

In an embodiment of the invention, said field source is configured for producing a magnetic field oriented in an axial direction and the lower winding, the lower arrangement of the field source, the upper arrangement of the filed source and the upper winding are arranged successively along the Z axis, in the upper direction.

In another embodiment of the invention, said field source is configured for producing a magnetic field oriented in an axial direction and the lower arrangement of the field source, the lower winding, the upper winding and the upper arrangement of the field source are arranged successively along the Z axis, in the upper direction.

In still another embodiment of the invention, said field source is configured for producing a magnetic field oriented in a radial direction and the lower winding is arranged outwards of the lower arrangement of the field source and the upper winding is arranged outwards of the upper arrangement of the field source in a radial direction.

In still another embodiment of the invention, said field source is configured for producing a magnetic field oriented in a radial direction and the lower winding is arranged inwards of the lower arrangement of the field source and the upper winding is arranged inwards of the upper arrangement of the filed source, in a radial direction.

Preferably, said upper arrangement of field source is identical to said lower arrangement of field source and in that said upper winding is identical to said lower winding. The relative position of said upper field source with respect to said lower field source may also result from a symmetry with respect to a plane perpendicular to the Z axis followed by a rotation around the Z axis

Said upper arrangement of field source and said lower arrangement of field source may then be formed as one single arrangement of field source.

Said upper and lower arrangement of field source may comprise each at least one selected from the group consisting of surface mounted permanent magnets, buried or inset permanent magnets, electromagnets supplied with DC currents, ferromagnetic parts having ferromagnetic saliencies in combination with a multi-phase winding.

Said stator portion may comprise a multi-phase winding comprising a plurality of pairs of windings arranged uniformly around the Z axis in a concentrated or distributed arrangement.

The windings may be configured as a wave winding or as lap windings.

A winding may comprises a plurality of p of coils, said plurality of coils being uniformly distributed around the Z axis, and arranged in subwindings connected together, either all in series or all in parallel, each of said subwinding having a same number n=1 to p of coils that are connected altogether, either all in series or all in parallel.

### SHORT DESCRIPTION OF THE DRAWINGS

These and further aspects of the invention will be explained in greater detail by way of example and with reference to the accompanying drawings in which:

FIG. 1 is a schematic representation of an electric machine according to the invention, wherein the field source produces an axial field;

FIG. 1bis is a schematic representation of an electric machine of FIG. 1, wherein the windings are formed from coils;

FIG. 2 is a schematic representation of another electric machine according to the invention, wherein the field source produces an axial field;

FIG. 3 is a schematic representation of still another electric machine according to the invention, wherein the field source produces an axial field;

FIG. 3bis is a schematic representation of still another electric machine according to the invention, wherein windings are formed as wave windings;

FIG. 4 is a schematic representation of still another electric machine according to the invention, wherein the field source produces an axial field and comprises ferromagnetic parts;

FIG. 5 is a schematic representation of an electric machine according to the invention, wherein the field source produces an axial field and wherein the pair of winding comprises three phases;

FIG. 6 is a schematic representation of an electric machine according to the invention, wherein the field source produces a radial field;

FIGS. 7a to 7e are schematic representations of exemplary interconnections of windings forming the pair of winding of an electric machine according to the invention;

FIGS. 8a and 8b are schematic representations of circuits representing the connections between the upper and lower windings;

FIG. 9 is a schematic representation of an equivalent electric circuit representing one phase winding of an pair of winding according to FIGS. 8a and 8b;

FIG. 10 is an implementation of an axial flux version of the invention;

FIG. 11 is an implementation of a radial flux version of the invention.

FIGS. 12a and 12b are graphs representing the magnetic flux across an upper winding φ_{U} and a lower winding φ_{L} in dependence of the angular position θ of the field source, for alternatives (a) and (b) of the invention, respectively.

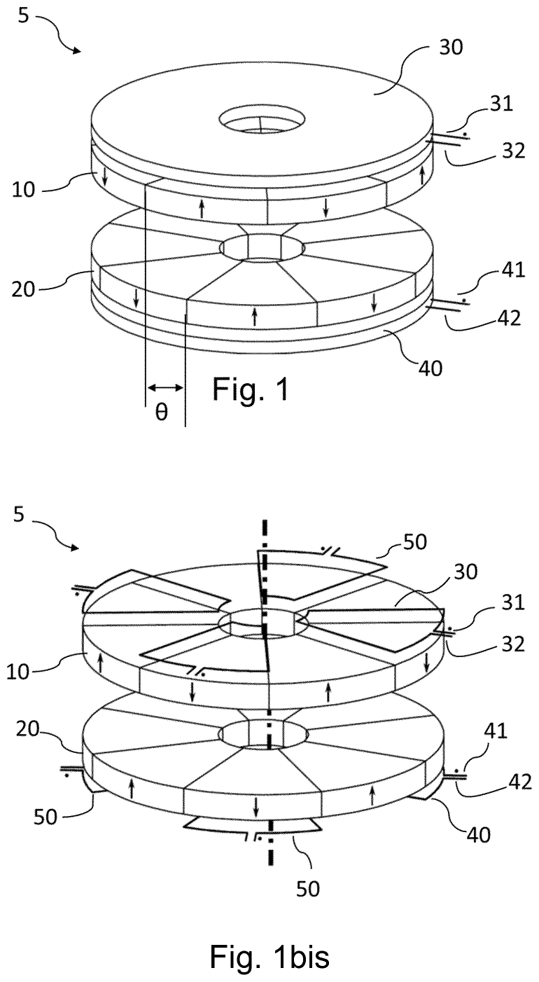

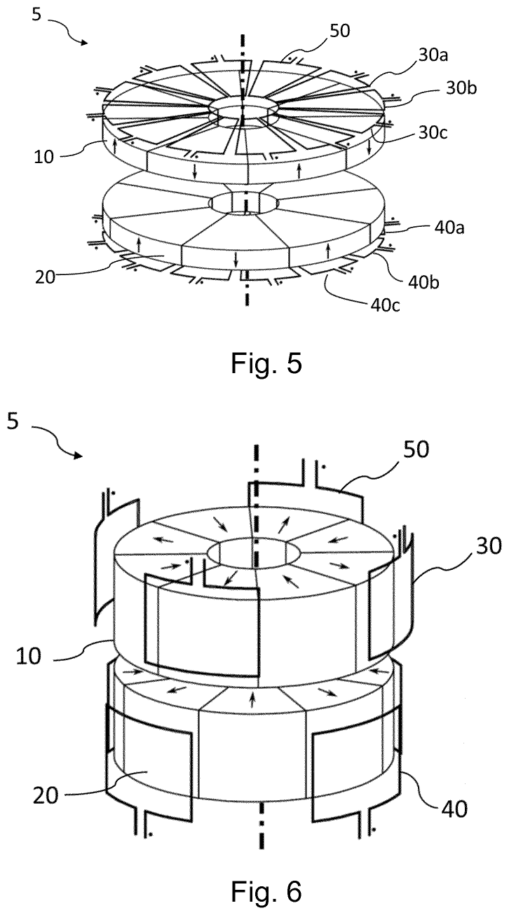

The drawings of the figures are neither drawn to scale nor proportioned. Generally, identical components are denoted by the same reference numerals in the figures. In the context of the present invention, the terms “upper” and “lower” are to be understood as meaning “in the positive direction of the Z-axis” and “in the negative direction of the Z-axis”, whatever the orientation of the Z-axis may be. In FIG. 1-bis to FIG. 6, the coils are represented as single-turn coils for the sake of clarity, but may be implemented as multi-turn coils or wave windings. With the exception of FIG. 5, all windings of FIG. 1-bis to FIG. 6 are represented as single-phase windings, for the sake of clarity, but may as well be multi-phase windings.

### DETAILED DESCRIPTION OF EMBODIMENTS OF THE INVENTION

FIG. 1 is a schematic representation of an electric machine 5 according to an embodiment of the invention, wherein the field source produces an axial field. A rotor of the electric machine 5 is configured for rotation around a Z-axis and comprises a field source having an upper arrangement 10 and a lower arrangement 20 of permanent magnets which are identical and produce each an axial magnetic field having a plurality p of pole pairs uniformly distributed around the Z-axis. In the example shown at FIG. 1, p is equal to 4. The upper arrangement 10 and the lower arrangement 20 may be shifted angularly relative to each other by an angle θ, as represented on FIG. 1 or may be aligned (θ=0) These arrangements 10, 20 may be made with surface-mounted, as represented, buried or inset permanent magnets, or respecting an Halbach array configuration. Permanent magnets may also be replaced by electromagnets supplied with DC currents, producing a magnetic field static with respect to the rotor. The stator of the electric machine comprises a pair of windings , comprising an upper winding 30 and a lower winding 40 which may be identical. The upper winding 30 comprises a positive reference terminal 31 and a negative reference terminal 32. The lower winding 40 comprises a positive reference terminal 41 and a negative reference terminal 42.

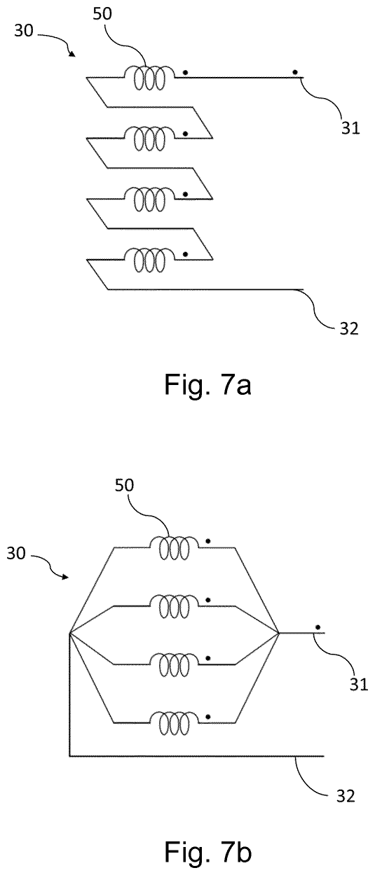

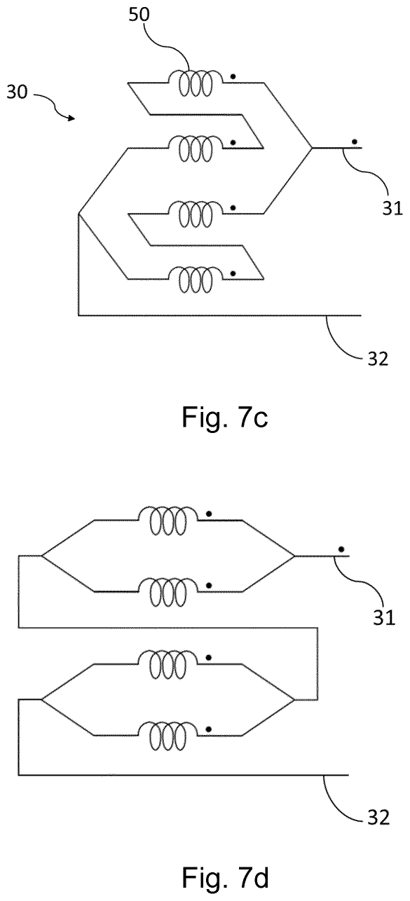

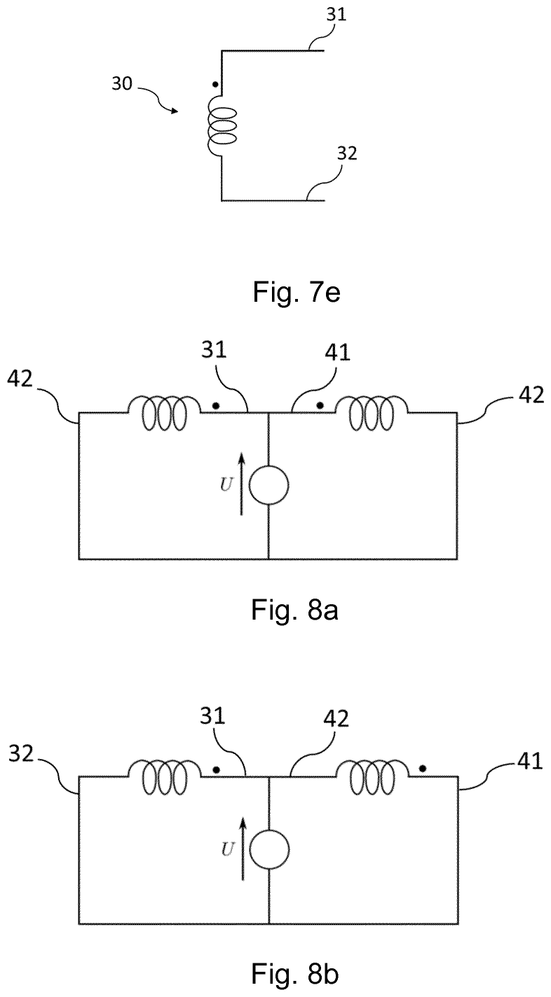

As represented on FIG. 1bis, the windings 30, 40 may comprise coils 50. Each winding 30, 40 comprises a plurality p of coils 50, uniformly distributed around the Z-axis, each coil 50 being magnetically linked to the magnetic field produced by the field source. In the context of the present invention, a coil may comprise a single turn or loop as represented on FIG. 1bis or may be a plurality of loops or turns. These coils 50 may have various geometries and can be placed in air, as represented, but also in front of a ferromagnetic yoke or in a slotted ferromagnetic circuit. The dot represented at each coil 50 defines a positive reference terminal such that, when the flux linked by the coil increases (resp. decreases), a positive (resp. negative) voltage/electromotive force is induced in the coil, referring to that terminal. Each winding 30, 40 is angularly shifted with respect to the pole pairs of the field source in such a way that either:
a) a flux of the field source through the upper set 30 of coils is maximal when the flux of the field source through the lower set 40 of coils is maximal; or
b) a flux of the field source through the upper set 30 of coils is maximal when the flux of the field source through the lower set 40 of coils is minimal;
   This may be obtained by arranging the upper 30 and lower 40 winding to have the same angular shift θ as the upper 10 and lower 20 arrangements of the field source, or angular shift θ+−π/p. The connections between the coils 50 within each winding 30, 40 and between both windings 30, 40 for obtaining the pair of winding are not represented, but will be discussed hereafter with reference to FIGS. 7a to 7e and FIGS. 8a-b. The rotor may rotate around the Z-axis, having a determined (centered or nominal) position where the upper 10 and lower 20 arrangement of the field source are at equal distance from the upper 30 and lower 40 winding of the pair of windings , respectively, and move freely along the Z-axis around this determined position. In the example of FIG. 1, the upper winding 30 of the pair of winding is located above the upper arrangement 10 of the field source, and the lower winding 40 of the pair of winding is located below the lower arrangement 20 of the field source. For the sake of clarity, the interconnections between the coils 50 for forming a winding 30 or 40 have not been represented on the FIG. 1a to FIG. 6.

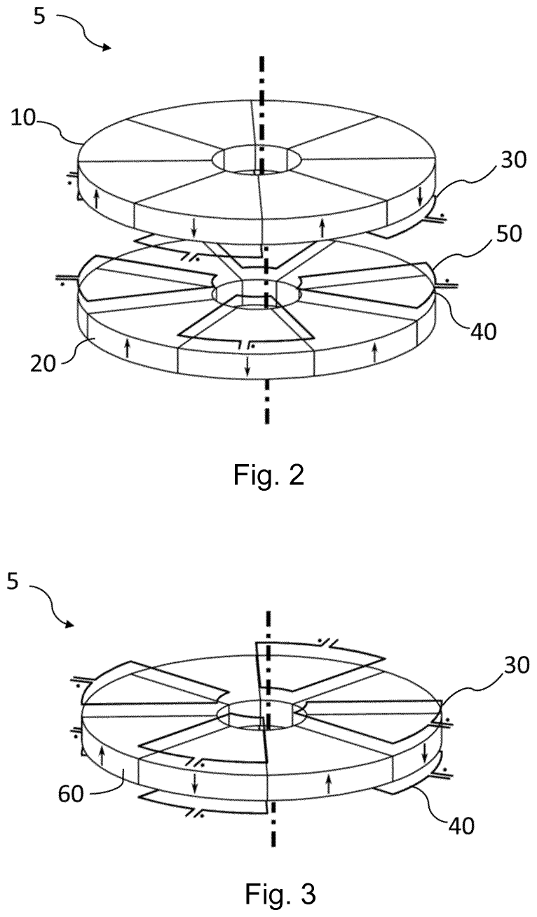

FIG. 2 is a schematic representation of another electric machine according to the invention, similar to the one of FIG. 1 but where the upper winding 30 of the pair of windings is located below the upper arrangement 10 of the field source, and the lower winding 40 of the pair of winding is located above the lower arrangement 20 of the field source, i.e. both upper arrangement 10 and lower arrangement 20 of the field source are external with respect to both upper set 30 and lower set 40 of coils.

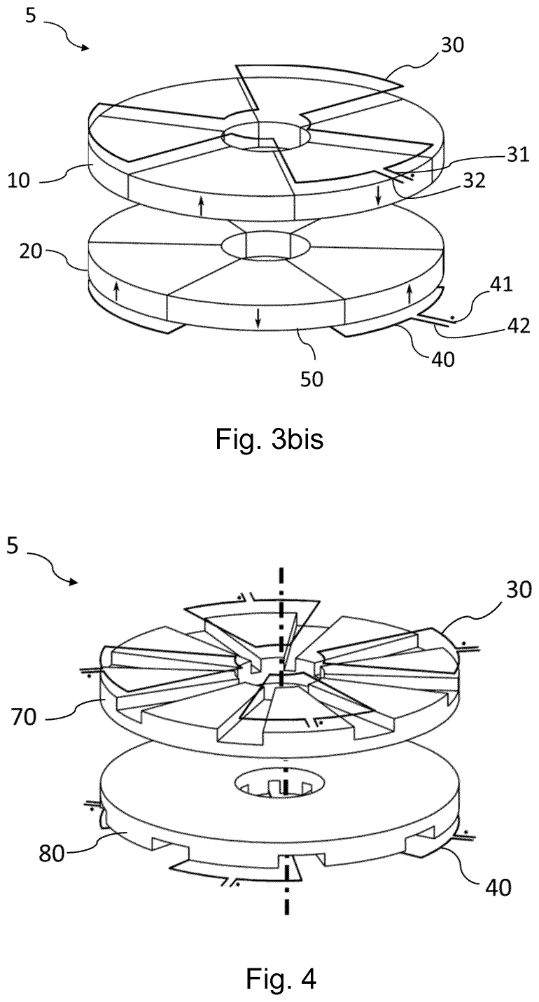

FIG. 3 is a schematic representation of still another electric machine according to the invention, similar to the one of FIG. 1 but wherein both upper arrangement 10 and lower arrangement 20 of permanent magnets comprised in the field source are merged into one single arrangement 60 of permanent magnets, producing an axial magnetic field having a plurality p (p=4) of pole pairs uniformly distributed around the Z-axis. The upper 30 and lower 40 winding are aligned (angular shift θ=0) with respect to each other. FIG. 3bis is a schematic representation similar to FIG. 3, but where the windings 30, 40 are wave windings. The number of poles pairs is three.

FIG. 4 is a schematic representation of still another electric machine according to the invention, similar to the one of FIG. 1 but wherein both upper arrangement 10 and lower arrangement 20 of permanent magnets comprised in the field source are replaced by an upper ferromagnetic part 70 and a lower ferromagnetic part 80 having both 2*p ferromagnetic saliencies in the axial direction. The field source produces an axial magnetic field having a plurality p (p=4) of pole pairs uniformly distributed around the Z-axis, through the magnetic polarization of these upper ferromagnetic part 70 and lower ferromagnetic part 80 by currents injected in multi-phase stator coils, as is well know from the field of reluctance machines. A multi-phase pair of winding of the invention may perform the function of multi-phase stator coils magnetizing the ferromagnetic parts 70, 80.

FIG. 5 is a schematic representation of an electric machine according to the invention, similar to the one of FIG. 1 but wherein the pair of winding may be a multi-phase winding 55.

The multi-phase pair of winding 55 comprises a plurality N (N=3 in the example shown) of upper windings 30a, 30b, 30c, and lower windings 40a, 40b, 40c uniformly distributed around the Z-axis. The coils 50 of a winding 30a, 30b, 30c, 40a, 40b, or 40c may be concentrated as represented but may also be distributed. The example of FIG. 5 comprises four pole pairs (p=4) and three phase windings (N=3).

FIG. 6 is a schematic representation of an electric machine according to the invention, wherein the field source produces a radial field; The field source, attached to a rotor portion, comprises an upper arrangement 10 and a lower arrangement 20 of permanent magnets which are identical and produce each a radial magnetic field having a plurality p of pole pairs uniformly distributed around the Z-axis. As for the embodiments of FIG. 1 to FIG. 5, the upper arrangement 10 and the lower arrangement 20 of FIG. 6 may be shifted angularly relative to each other (by an angle θ) or may be aligned (θ=0). These arrangements 10, 20 may also be made with surface mounted magnets, buried or inset permanent magnets, or respecting an Halbach array configuration. Permanent magnets may also be replaced by electromagnets supplied with DC currents. As for the axial flux versions of the invention, both upper arrangement 10 and lower arrangement 20 of permanent magnets may be replaced by a single arrangement, also producing a radial magnetic field having a plurality p of pole pairs uniformly distributed around the Z-axis. The pair of winding may also comprise a multi-phase winding comprising a plurality N of phase windings uniformly distributed around the Z-axis. In the same way as represented on FIG. 2, the arrangements of permanents magnets may be external with respect to the pair of winding.

FIGS. 7a to 7e are schematic representations of exemplary interconnections of either the upper 30 or the lower 40 winding forming an pair of winding of an electric machine according to the invention. The p coils 50 of each winding 30, 40 are regrouped in subwinding, each subset comprising a same number of one or more of coils 50 that are connected altogether, either all in series or in parallel. These subwindings are themselves connected altogether, either all in series or in parallel. FIGS. 7a to 7d represent the case where p=4. In FIG. 7a, the four coils 50 are connected in series within one subset. In FIG. 7b, the four coils 50 are connected in parallel within one subset. In FIG. 7c, the four coils 50 are regrouped in pairs connected in series and form two subsets. These two subsets are themselves connected in parallel. In FIG. 7d, the four coils 50 are regrouped in pairs connected in parallel and form two subsets. These two subsets are themselves connected in series. In FIG. 7c, the four coils 50 are regrouped in pairs connected in series and forming two subsets. These two subsets are themselves connected in parallel. It is to be noted that when the coils 50 of a winding 30, 40 and the arrangements of the field source are arranged as discussed, the voltage/electromotive force induced in the individual coils by rotation of the electric machine have same phase. The dots represented on FIG. 7a to FIG. 7e show that the individual coils are connected in such a way that voltage/electromotive force induced in the coils add up when the coils are series connected, and that the currents flowing in the coils add up when parallel connected. These modes of connections should notably allow adapting the voltages and currents levels. Once these subwindings are connected altogether forming one winding, said winding can be represented equivalently in FIG. 7e as a single coil 30 or 40, having each a positive reference terminal 31 or 41 and a negative reference terminal 32 or 42, respectively. For electric machines having a number of pole pairs not equal to 4, the skilled person will easily design the possible coil arrangements, e.g. the six coils of a six pairs-of-poles electric machine may be arranged in six-in-series, six-in-parallel, two subsets of three in parallel, three subsets of two in parallel.

FIGS. 8a and 8b are schematic representations of a circuit representing one pair of windings comprising both upper 30 and lower 40 winding of FIG. 7e. The voltage source U corresponds to an external electric supply feeding the motor when the electric machine is a motor, or to the voltage applied on an electric load connected to the electric machine when it is a generator. In FIG. 8a, the flux of the field source through the upper set 30 of coils is maximal when the flux of the field source through the lower set 40 of coils is maximal, resulting in a parallel connection of both windings. By contrast, in FIG. 8b, the flux from the field source through the upper set 30 of coils is maximal when the flux from the field source through the lower set 40 of coils is minimal, resulting in an anti-parallel connection of both windings. These connections are chosen in such a manner that
i) the net variation of the flux through the pair of windings when the pair of windings and the field source are in rotation with respect to each other is zero when the rotor is centred along the Z-axis, and different from zero for any other position of the rotor along the Z-axis and
ii) a torque is produced or absorbed when the electric machine/pair of winding is connected to a power supply or to an electric load.
   In FIG. 8a, the positive reference terminal (31) of the upper winding (30) is connected to the positive reference terminal (41) of the lower winding (40) and the negative reference terminal (32) of the upper winding (30) is connected to the negative reference terminal (42) of the lower winding (40), forming a closed circuit path.
   In FIG. 8b, the positive reference terminal (31) of the upper winding (30) is connected to the negative reference terminal (42) of the lower winding (40) and the negative reference terminal (32) of the upper winding (30) is connected to the positive reference terminal (41) of the lower winding (40) when alternative (b) is realized, forming a closed circuit path.

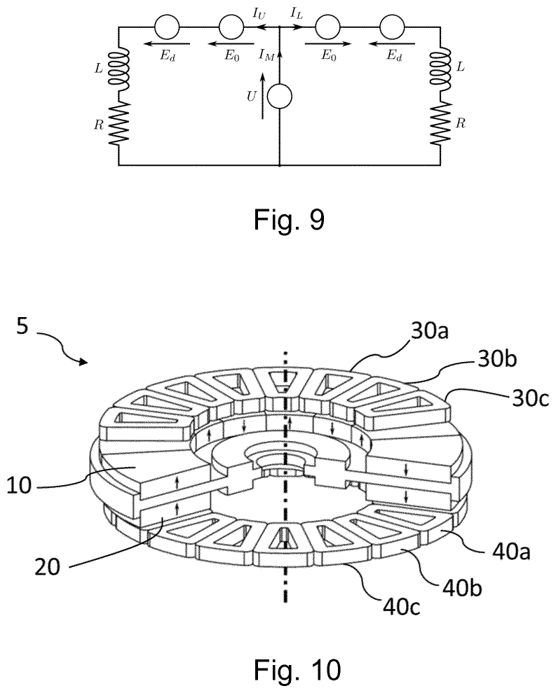

FIG. 9 is a schematic representation of an equivalent electric circuit representing a pair of windings or a single phase of a multi-phase winding 55, comprising an upper winding 30 and a lower winding 40 connected as represented on FIG. 8a or FIG. 8b.The left and right branches of the circuit correspond respectively to the upper winding 30 and lower winding 40. Both branches have the same resistance R, and inductance L. They are the seat of electromotive forces E₀ and E_{d}, respectively. The voltage source U corresponds to the external electric supply feeding the motor when the electric machine is a motor, or to the voltage applied to the electric load connected to the electric machine when it is a generator. E₀ is the electromotive force induced by the component of the magnetic field generated by the field source in the pair of windings when the rotor is located at its determined position along the Z-axis (i.e. centered). This magnetic field component, and therefore the electromotive force E₀, does not depend on the decentring amplitude. E_{d} is the electromotive force induced by the component of the magnetic field appearing on the pair of windings when the rotor is not centred along the Z-axis. Considering that the rotor decentring amplitude is small (compared to the air gap thickness), this magnetic field component, and therefore the electromotive force E_{d}, is proportional to the decentring amplitude. As a result of the mode of connection between the upper winding 30 and lower winding 40 as well as the angular shift θ between the upper arrangement 10 and lower arrangement 20 of permanent magnets, and between the upper winding 30 and lower winding 40, the electromotive force E₀ is opposite in sign in both windings whereas the electromotive force E_{d} has the same sign in both windings. Consequently, the electrical equations of the equivalent electric circuit of FIG. 9 are:

U+E₀+Ed−RI_{U}−jωLI_{U}=0

U+E₀−Ed−RI_{L}−jωLI_{L}=0

I_{M}=I_{U}+I_{L}

As a result, when the rotor is centred along the Z-axis, E_{d}=0 and

I_{U}=I_{L}=(U+E₀)/(R+jωL)

I_{M}=2(U+E₀/(R+jωL)

The current I_{U}=I_{L} circulating in the upper winding 30 and lower winding 40 only contributes to the torque generation of the rotor, but not to the restoring force. When the rotor is not centred, E_{d}≠0 and:

I_{U}=(U+E₀)/(R+jωL)+E_{d}/(R+jωL)

I_{L}=(U+E₀)/(R+jωL)−E_{d}/(R+jωL)

I_{M}=2(U+E₀)/(R+jωL)

The additional current component due to the decentering in the upper winding 30 and lower winding 40 only contributes to the generation of a restoring force, but is not delivered by/to the external source U since the current the current I_{M} remains unchanged.

The combination of field source and upper and lower windings as discussed above produces a null-flux winding. No current flows into the closed circuit formed by the connections of the upper 30 and lower 40 winding when the rotor is at its determined (nominal) position. When the rotor is displaced from its determined position, a net flux through these windings produces a current interacting with the field source producing a force bringing the rotor back to its determined position. In addition, the connections (31-42, 32-41 or 31-41, 32-42) between the upper (30) and lower (40) windings form terminals of the electric machine that may be used for feeding directly a load when the electric machine is a generator, or for connecting to a power source when the electric machine is a motor.

FIG. 10 is an implementation of an axial flux version of the invention. The field source comprises axially magnetized permanents magnets producing an axial magnetic field having 6 pole pairs (p=6). The upper arrangement 10 and lower arrangements 20 of permanent magnets are placed on a ferromagnetic part 15. The multi-phase winding 55 comprises three phases having upper windings 30a, 30b and 30c, and lower windings 40a , 40b, 40c, respectively arranged in a concentrated way around the Z axis. The upper windings 30a, 30b, 30c and lower windings 40a, 40b, 40c of each phase see a maximal flux due to the field source at the same time and are therefore connected in parallel to the external electric supply feeding the motor when the electric machine is a motor, or to the voltage applied on the electric load connected to the electric machine when it is a generator.

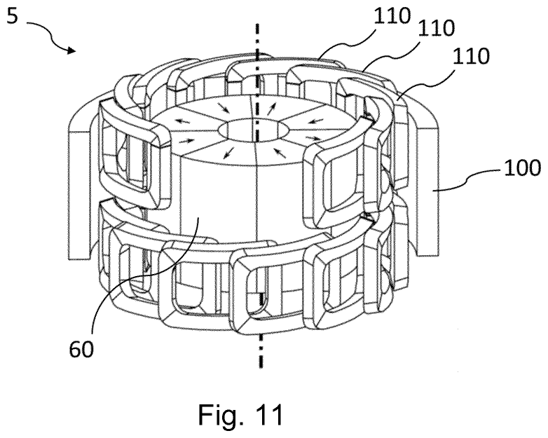

FIG. 11 is an implementation of a radial flux version of the invention. The field source comprises one single arrangement 60 of radially magnetized permanents magnets producing a radial magnetic field having 4 pole pairs. The stator winding comprises 3 phases, themselves composed of two sets of distributed overlapping coils 110. The upper winding 30 and lower winding 40 of coils have to be connected in parallel to the external electric supply feeding the motor when the electric machine is a motor, or to the voltage applied on the electric load connected to the electric machine when it is a generator. A ferromagnetic part 100 may be placed around the pair of winding and may be attached to the stator portion or to the rotor portion of the electric machine.

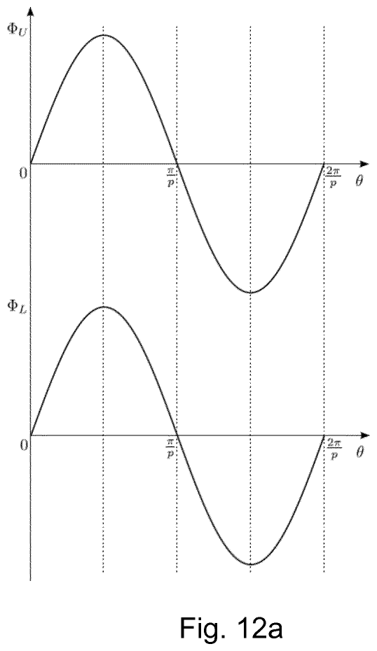

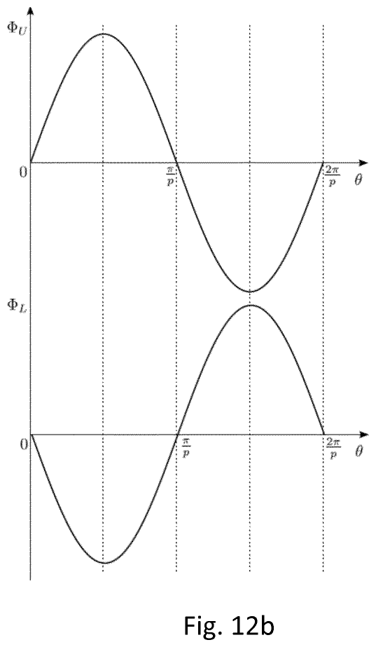

FIGS. 12a and 12b are graphs representing the magnetic flux across an upper winding 30 (φ_{U}) or lower winding 40 (φ_{L}) in dependence of the angular position θ of the field source. FIG. 12a and FIG. 12b represent the fluxes when the arrangements of the upper 30 and lower 40 windings are as described under (a) and (b) above, respectively. The amplitudes of the fluxes φ_{U} and φ_{L} are equal when the rotor rotates at its determined, nominal position, and are not equal when the rotor deviates from the determined position.

The invention allows the design of an electric machine combining a passive axial electrodynamic bearing and a motor or generator with a single pair of windings. The upper (30) and the lower (40) windings form an electrodynamic thrust bearing and are able to produce a torque when the electric machine/pair of windings is connected to a power supply or to an electric load. The electrodynamic bearing of the invention addresses the axial degree of freedom of the rotor. The skilled person will know how to design an electric machine where the other degrees of freedom of the rotor, i.e. the radial degree of freedom and the angular attitude of the rotor are taken into account, e.g. by conventional bearings, or by radial electromagnetic bearings, either active or passive. The electric machine of the invention has many advantages, such as the absence of contact and of wear and therefore no generation of particles. No lubricant is needed. These advantages find applications in fields requiring vacuum, high purity, reliability, high speed. The electric machine of the invention may be used for flywheels, ventricular pumps and high purity pumps. In the examples discussed above, the number of pole pairs was 3 or 4. The invention applies as well to electric machines having other values of p, e.g. p=1, p=5, p=6 or more.

1. An electric machine extending along an axis Z, and comprising:
1) a rotor portion configured for rotating around the Z axis at a defined position along the Z axis and comprising a field source having an upper field source arrangement and a lower field source arrangement producing a magnetic field, and comprising a plurality of p pole pairs uniformly distributed around the Z axis;
2) a stator portion comprising at least one pair of windings comprising each an upper and a lower winding, comprising each a plurality of p pole pairs uniformly distributed around the Z axis, at least one of the upper winding or the lower winding having a positive reference terminal and a negative reference terminal, a positive current flowing into a positive reference terminal producing a positive flux in said winding, wherein for the or each pair of windings:
each winding and the field source are arranged in such a way that either alternative:
(a) a flux from the field source in said upper winding is equal to the flux from the field source in said lower winding; or
(b) a flux from the field source in said upper winding is opposite to the flux from the field source in said lower winding;
is realized at any time when the rotor portion rotates around the Z axis at said defined position along the Z axis;
each winding and the field source are arranged in such a way that the amplitude of a flux from the field source increases in a winding of said pair of windings and decreases in the other winding of said pair of windings when position of the rotor portion along the Z axis is different from said defined position;
the positive reference terminal of the upper winding is connected to the positive reference terminal of the lower winding and the negative reference terminal of the upper winding is connected to the negative reference terminal of the lower winding when alternative (a) is realized and the positive reference terminal of the upper winding is connected to the negative reference terminal of the lower winding and the negative reference terminal of the upper winding is connected to the positive reference terminal of the lower winding when alternative (b) is realized, forming a closed circuit path;
wherein the connections between the upper and lower windings comprise terminals of the electric machine directly connectable to an electric power supply or to an electric load.

2. The electric machine according to claim 1, wherein said field source is configured for producing a magnetic field oriented in an axial direction and in that the lower winding, the lower arrangement of the field source, the upper arrangement of the field source and the upper winding are arranged successively along the Z axis, in the upper direction.

3. The electric machine according to claim 1, wherein said field source is configured for producing a magnetic field oriented in an axial direction and in that the lower arrangement of the field source, the lower winding the upper winding and the upper arrangement of the field source are arranged successively along the Z axis, in the upper direction.

4. The electric machine according to claim 1, wherein said field source is configured for producing a magnetic field oriented in a radial direction and in that the lower winding is arranged outwards of the lower arrangement of the field source and the upper winding is arranged outwards of the upper arrangement of the field source, in a radial direction.

5. The electric machine according to claim 1, wherein said field source is configured for producing a magnetic field oriented in a radial direction and in that the lower winding is arranged inwards of the lower arrangement of the field source and the upper winding is arranged inwards of the upper arrangement of the field source, in a radial direction.

6. The electric machine according to claim 1, wherein said upper arrangement of field source is identical to said lower arrangement of field source and in that said upper winding is identical to said lower winding.

7. The electric machine according to claim 6, wherein the relative position of said upper field source with respect to said lower field source results from a symmetry with respect to a plane perpendicular to the Z axis followed by a rotation around the Z axis.

8. The electric machine according to claim 7, wherein said upper arrangement of field source and said lower arrangement of field source are formed as one single arrangement of field source.

9. The electric machine according to claim 1, wherein said upper and lower arrangement of field source include at least one of a surface mounted permanent magnet, a buried or inset permanent magnet, an electromagnet supplied with DC currents, a ferromagnetic part having ferromagnetic saliencies in combination with a multi-phase winding.

10. The electric machine according to claim 1, wherein said stator portion comprises a multi-phase winding comprising a plurality of pairs of windings arranged uniformly around the Z axis in a concentrated or distributed arrangement.

11. The electric machine according to claim 1, wherein a winding is configured as a wave winding.

12. The electric machine according to claim 1, wherein a winding is configured as a lap winding.

13. The electric machine according to claim 12, wherein a said winding comprises a plurality, p, of coils, said plurality of coils being uniformly distributed around the Z axis, and arranged in subwindings connected together, either all in series or all in parallel, each of said subwinding having a same number n=1 to p of coils that are connected altogether, either all in series or all in parallel.
